(19) United States
(12) Patent Application Publication
(10) Pub. No.: US 2023/0278653 A1
(43) Pub. Date: Sep. 7, 2023

(54) VEHICLE HEIGHT SENSOR

(71) Applicant: R.A. PHILLIPS INDUSTRIES, INC., Santa Fe Springs, CA (US)

(72) Inventors: Daniel William Forthoffer, Birmingham, MI (US); John Patrick Cavanagh, Windermere, FL (US); John Sasta, Shelby Township, MI (US)

(21) Appl. No.: 18/179,261

(22) Filed: Mar. 6, 2023

Related U.S. Application Data
(60) Provisional application No. 63/317,367, filed on Mar. 7, 2022.

(51) Int. Cl. B62D 63/08; G01S 17/08; G01S 15/08

(52) U.S. Cl. CPC B62D 63/08; G01S 17/08; G01S 15/08; B60W 50/14

(57) ABSTRACT

A sensing device includes a range sensor configured to emit a signal toward the ground and to measure a distance between the range sensor and the ground, a sensor housing configured to house the range sensor, the sensor housing having a first opening through which the range sensor is configured to emit the signal, and a coupling member attached to the sensor housing and configured to couple the sensor housing to a body of a trailer or a chassis.

### CROSS-REFERENCE TO RELATED APPLICATION

This application claims priority to, and the benefit of, U.S. Provisional Application No. 63/317,367 (“KINGPIN HEIGHT SENSOR”), filed on Mar. 7, 2022, the entire content of which is incorporated herein by reference.

### FIELD

The present invention relates to trailer coupling systems and methods of using the same.

### BACKGROUND

Generally, in order for a motorized vehicle to tow a trailer, there is a connection methodology that allows the trailer to rotate to a certain extent both vertically and horizontally in relation to the motorized vehicle while towing the trailer through the use of a hitch, fifth wheel, or other apparatus. This hitch, fifth wheel, or other apparatus with similar functionality is used to connect and disconnect the trailer from the motorized vehicle as well as maintain the connection between the motorized vehicle to the trailer during most, if not all, of the circumstances encountered while the motorized vehicle is towing the trailer.

In fifth wheel coupling, a kingpin on the trailer side couples with the horseshoe-shaped fifth wheel on the tow vehicle side. A kingpin is a part of the coupling mechanism between the semi-trailer and the tractor unit. This vertical pin protrudes from the bottom of the front of a semi-tractor trailer toward the fifth wheel on the rear of the towing vehicle. As the connected truck turns, the downward-facing surface of the semi-trailer (with the kingpin at the center) rotates against the upward-facing surface of the fixed fifth wheel, which does not rotate.

To couple the fifth wheel and the kingpin, it is important that both are located at the same distance from the ground. Because not every tractor fifth wheel or trailer kingpin has the same height, prior to coupling, height adjustments may be made on the tractor trailer by utilizing a mechanism, manual or electrical, on the landing legs to adjust the trailer (and kingpin) height. This task is performed manually and visually by the vehicle operator. If the heights are not adjusted, the tractor could back into and damage the trailer.

The above information disclosed in this Background section is only for enhancement of understanding of the background of the invention and therefore it may contain information that does not form the prior art that is already known to a person of ordinary skill in the art.

### SUMMARY

Aspects of embodiments of the present invention are directed to a vehicle height sensing system including a sensing device that is capable of determining the height of the trailer kingpin. In some embodiments, the vehicle height sensing systems is capable of communicating the height data to a dispatcher/fleet manager and/or a cab of the truck coupled to the trailer to enable adjustment (e.g., automated adjustment) of the height of the trailer's landing legs to match the kingpin and fifth wheel distances from ground. This feedback of the kingpin height may facilitate the operation of driverless and/or autonomous vehicles and/or automated coupling systems. The sensing device may be mounted to the underside of a trailer or chassis.

According to some embodiments, there is provided a sensing device including: a range sensor configured to emit a signal toward the ground and to measure a distance between the range sensor and the ground; a sensor housing configured to house the range sensor, the sensor housing having a first opening through which the range sensor is configured to emit the signal; and a coupling member attached to the sensor housing and configured to couple the sensor housing to a body of a trailer or a chassis.

In some embodiments, the range sensor includes a time-of-flight (ToF) sensor, and the signal comprises a light signal or a sound wave.

In some embodiments, the range sensor includes: an emitter configured to emit the signal toward the ground; a receiver configured to receive a reflected signal from the ground; and a processing circuit configured to calculate the distance between the range sensor and the ground based on an emission time of the signal and a receive time of the reflected signal, and to determine a height of a kingpin of the trailer or the chassis based on the calculated distance.

In some embodiments, the processing circuit is configured to determine the height of the kingpin further based on a calibration value corresponding to a vertical distance between the kingpin and the range sensor.

In some embodiments, the range sensor further includes: a communication circuit in electrical communication with a telematics gateway circuit at the trailer or the chassis, and configured to transmit data generated by the processing circuit to the telematics gateway circuit over a controller area network (CAN) bus of the trailer or the chassis, an RS232/485 connection, a power line communication (PLC) connection, or a wireless communication link.

In some embodiments, the range sensor is coupled to an electrical system of the trailer or the chassis, and is configured to receive electrical power from at least one of an electrical circuit of an anti-lock braking system (ABS) of the trailer or the chassis, a light circuit providing power to lights of the trailer or the chassis, a power-over-ethernet (PoE) connection, or a storage battery at the trailer or the chassis.

In some embodiments, the range sensor is configured to determine a height of a kingpin of the trailer or the chassis based on the distance between the range sensor and the ground, and to transmit the height of the kingpin.

In some embodiments, the sensor housing accommodates the range sensor and is fixedly coupled to the coupling member.

In some embodiments, the sensor housing includes glass-filled nylon material.

In some embodiments, the coupling member includes: a fixing member; and a first fastener and a second fastener facing one another, the first and second fasteners being configured to be attached to the fixing member and to grip a flange of an I-beam at an underside of the trailer or the chassis.

In some embodiments, the first fastener includes: a first U-shaped clip having two parallel arms that extend along and overlap the flange, one of the two parallel arms having a threaded through hole to enable a bolt to screw through and apply compressive force against the flange of the I-beam and to fasten the first U-shaped clip to the I-beam; and a first stem extending from an other one of the two parallel arms and configured to be fastened to the fixing member.

In some embodiments, the fixing member has a fixing stem portion configured to be coupled to the first and second fasteners, and a U-shaped bracket portion configured to be mounted to two sides of the sensor housing.

According to some embodiments, there is provided a sensing device including: a sensor housing configured to be coupled to a body of a trailer or a chassis, the trailer or chassis having a kingpin configured to couple the trailer or the chassis to a tractor; and a range sensor in the sensor housing and configured to emit a signal toward the ground, to measure a distance between the range sensor and the ground, and to determine a height of the kingpin based on the measured distance.

In some embodiments, the range sensor is further configured to receive a reflected signal from the ground, to calculate the distance between the range sensor and the ground based on an emission time of the signal and a receive time of the reflected signal, and to determine the height of the kingpin of the trailer or the chassis based on the calculated distance and a calibration value corresponding to a vertical distance between the kingpin and the range sensor.

In some embodiments, the range sensor is configured to be in electrical communication with at least one of a telematics gateway circuit at the trailer or the chassis, the tractor coupled to the trailer or the chassis, or automated landing legs of the trailer or the chassis.

In some embodiments, the range sensor is configured to transmit data corresponding to the height of the kingpin to a telematics gateway circuit at the trailer or the chassis over a controller area network (CAN) bus of the trailer or the chassis, an RS232/485 connection, a power line communication (PLC) connection, or a wireless communication link.

In some embodiments, the sensing device further includes: a coupling member attached to the sensor housing and configured to couple the sensor housing to an underside of the trailer or the chassis, the coupling member including: a fixing member; and a first fastener and a second fastener facing one another, the first and second fasteners being configured to be attached to the fixing member and to grip a flange of an I-beam at the underside of the trailer or the chassis.

According to some embodiments, there is provided a vehicle height sensing system including: a sensing device including: a sensor housing configured to be coupled to a body of a trailer or a chassis, the trailer or chassis having a kingpin configured to couple the trailer or the chassis to a tractor; and a range sensor in the sensor housing and configured to emit a signal toward the ground, to measure a distance between the range sensor and the ground, and to determine a height of the kingpin based on the measured distance; and a telematics gateway circuit at the trailer or the chassis and configured to be in electrical communication with the sensing device.

In some embodiments, the telematics gateway circuit is at a nose box of the trailer or the chassis and is configured to wirelessly transmit data corresponding to the height of the kingpin via a cellular or a broadband connection to an external server or a tractor cab.

In some embodiments, the range sensor is configured to transmit data corresponding to the height of the kingpin to the telematics gateway circuit over a controller area network (CAN) bus of the trailer or the chassis, an RS232/485 connection, a power line communication (PLC) connection, or a wireless communication link.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention, but are intended to be illustrative only.

FIG. 1 illustrates a vehicle utilizing the vehicle height sensing system, according to some embodiments of the present disclosure.

FIG. 2 illustrates a block diagram of the sensing device of the vehicle height sensing system, according to some embodiments of the present disclosure.

FIG. 3 illustrates a bottom perspective view of the sensing device, according to some embodiments of the present disclosure.

FIGS. 4A and 4B illustrate a side view and a frontal view, respectively, of the sensing device, according to some embodiments of the present disclosure.

FIGS. 5A and 5B illustrate a top perspective view and a bottom perspective view, respectively, of the sensing device, according to some embodiments of the present disclosure.

FIGS. 6A and 6B illustrate and interior view of the top portion and the bottom portion 232, respectively, of the sensor housing, according to some embodiments of the present disclosure.

FIG. 7 illustrates a partially exploded side-view of sensing device 200, according to some embodiments of the present disclosure.

FIG. 8 illustrates a side view of a coupling member of the sensing device, according to some embodiments of the present disclosure.

### DETAILED DESCRIPTION

The detailed description set forth below in connection with the appended drawings is intended as a description of illustrative embodiments of an auto-coupling system in accordance with the present invention, and is not intended to represent the only forms in which the present invention may be implemented or utilized. The description sets forth the features of the present invention in connection with the illustrated embodiments. It is to be understood, however, that the same or equivalent functions and structures may be accomplished by different embodiments that are also intended to be encompassed within the spirit and scope of the present invention. As denoted elsewhere herein, like element numbers are intended to indicate like elements or features.

Aspects of embodiments of the present disclosure are directed to a vehicle height sensing system mounted to the undercarriage of a trailer or chassis, which is capable of measuring the height of the trailer/chassis kingpin and reporting this information to the driver of the vehicle, a controller or control system within the vehicle and/or to a dispatch/external server.

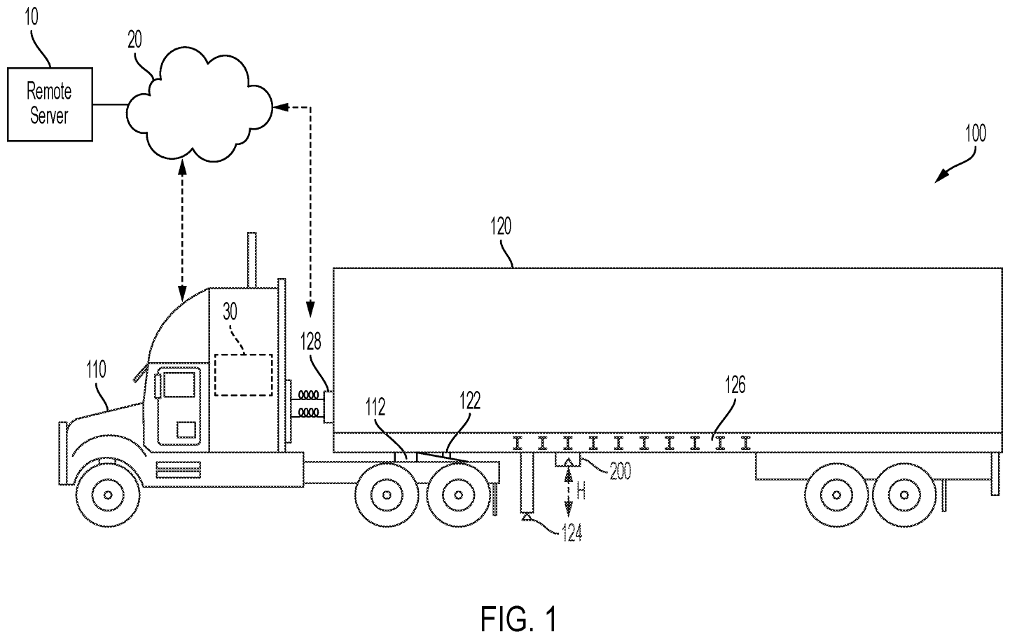

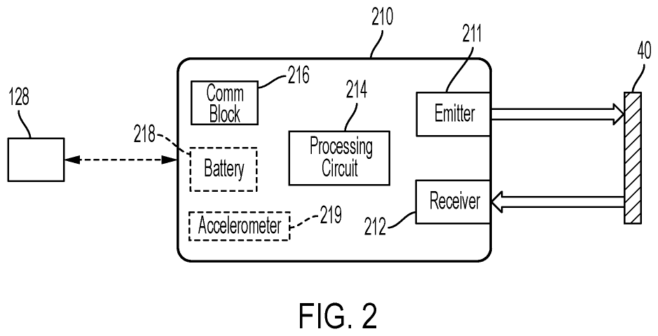

FIG. 1 illustrates a vehicle utilizing the vehicle height sensing system, according to some embodiments of the present disclosure. FIG. 2 illustrates a block diagram of the sensing device of the vehicle height sensing system, according to some embodiments of the present disclosure.

As illustrated in FIG. 1, the heavy-duty vehicle 100 includes a tractor (or tow vehicle) 110 coupled to a trailer/chassis 120. The tractor 110 includes a fifth wheel 112 that is configured to rotatably couple to the kingpin 122 of the trailer/chassis 120. The trailer/chassis 120 also includes landing legs 124, which are retractable support gear that keep the trailer/chassis 120 level when not connected to a tractor 110.

In some embodiments, the trailer/chassis 120 is coupled to a vehicle height sensing system (128 and 200), which includes a sensing device (e.g., a kingpin height sensing device) 200 fixedly mounted to an underside (e.g., an undercarriage) of the trailer/chassis 120 and aimed down toward the ground beneath the trailer/chassis 120. In some examples, the sensing device 200 may be mounted to a cross bar (e.g., a T-bar or I-beam) 126 at the undercarriage of the trailer/chassis 120 at a position between the trailer/chassis kingpin 122 and back of the trailer/chassis 120, which allows the sensing device 200 to remain clear of damage during coupling of the tractor 110 and trailer/chassis 120 while still providing clear and accurate readings.

According to some embodiments, the sensing device 200 includes a range sensor 210 (e.g., a time-of-flight (ToF) sensor) that emits a signal, such as a light signal (e.g., a laser beam) or a sound wave (e.g., an ultrasonic soundwave) vertically down toward the ground and measures the time it takes for the reflected signal to return to the sensing device 200 after reflecting off of the ground. This allows the sensing device 200 to measure the distance between it and the ground (i.e., the height H).

Because both of the kingpin 122 and sensing device 200 are configured to be mounted to static points on the trailer/chassis 120, the vertical position of the sensing device 200 relative to the trailer/chassis kingpin 122, when mounted, is fixed and is a known value (e.g., can be determined at the time of installation). In some embodiments, the height difference is calibrated into the sensing device 200 to allow it to determine (e.g., calculate) the height of the kingpin 122 relative to ground 40 (e.g., the distance between the bottom of the kingpin 122 and ground 40) at any given time. In some examples, the sensing device 200 may be mounted in a way as to be on the same vertical plane as the kingpin, such that the calibration value may be zero or substantially zero. According to some embodiments, the calibration value, which corresponds to (e.g., is equal to) a vertical distance between the kingpin 122 and the range sensor 210, may be programmed into the range sensor 210 (e.g., after installation), via a wired connection (e.g., a controller area network (CAN) connection, an RS232/485 connection, or a power line communication (PLC) connection) or a wireless connection (e.g., a bluetooth or wifi connection) to a user device (e.g., a mobile phone or tablet). The calibration value may be reprogrammed at any time as may be desired (e.g., in response to the sensing device 200 moving relative to its initial position).

In some embodiments, the vehicle height sensing system, which includes the sensing device 200 and a telematics gateway 128, is capable of communicating the height information, as well as other information, to the driver and/or the dispatch/fleet manager, thus making it easier to determine how to adjust the length of the landing legs 124 so that the vertical position of the kingpin 122 can be made to match that of the tractor fifth wheel 112. This may be of particular relevance in autonomous driving applications where the tractor 110 and/or trailer/chassis 120 may be able to adjust the height of the fifth wheel 112 and/or kingpin 122 without user intervention (e.g., do so automatically).

In some examples, a parked trailer/chassis 120 equipped with the vehicle height sensing system (128 and 200) may transmit (e.g., broadcast) the height of the kingpin to a nearby tractor 110 that is attempting to couple with the trailer/chassis 120. If the tractor 110 is equipped with adaptive suspension, it may adjust the height of the fifth wheel 112 (e.g., by raising or lowering its suspension) to match that of the kingpin 122.

In other examples, the trailer/chassis 120 may be equipped with motorized landing legs 124 that are capable of raising and lowering the nose of the trailer/chassis 120, and hence adjusting the height of the kingpin 122. In such examples, the trailer/chassis 120 may monitor for nearby tractors, identify the nearest tractor that is within sufficient proximity to indicate an intent to couple with the trailer, obtain fifth wheel height information from the tractor 110, and adjust the length of the landing legs 124 so that the height of the kingpin 122 matches that of the identified tractor 110. The trailer/chassis 120 may obtain the fifth wheel height information by pinging the tractor 110 (e.g., wirelessly) and receiving a response with the height information, or by scanning a label on the truck that indicates its fifth wheel height.

In autonomous driving examples in which the trailer is equipped with automatic landing legs that are capable of determining and adjusting the trailer height, the sensing device 200 may operate as a redundant sensor that can be used to determine the proper functioning of the landing legs. For example, when the readings from the sensor 200 matches that of the landing gear, then the trailer height may be adjusted. However, if the readings don't agree, the operation of the trailer may be halted and it may be placed out of service.

As will be understood by a person of ordinary skill in the art, the height communication methodologies described above are merely examples, and the present disclosure is not limited thereto.

Referring to FIG. 2, in some embodiments, the sensing device 200 includes a range sensor 210 having a number of electronic components mounted to one or more substrates (e.g., one or more printed circuit boards (PCBs)) that are housed within a sensor housing. The range sensor 210 includes an emitter (e.g., a light source, such as a light emitting diode (LED) or laser, or an ultrasonic emitter) 211 configured to emit the signal (e.g., light, laser, or soundwave) toward the ground 40, a receiver 212 that is configured to receive the reflected signal from the ground 40, and a processing circuit 214 that is configured to calculate the distance between the range sensor 210 and the ground 40 based on an emission time of the signal and a receive time of the reflected signal (i.e., the time of flight).

In some embodiments, the range sensor 210 is coupled to the electrical system of the trailer/chassis 120 and is electrically powered from the electrical circuit of the anti-lock braking system (ABS) and/or the light circuit providing power to the lights of the trailer/chassis 120. In some examples, the range sensor 210 may be electrically powered by simply tapping into the existing anti-lock braking system (ABS) power line or the wires leading to the lights, which eliminates the need to lay down lengthy wires at the trailer/chassis 120 to power the sensing device 200. However, embodiments of the present disclosure are not limited thereto. For example, the sensing device 200 may be powered by a solar panel on the roof of the trailer/chassis 120, a power-over-ethernet (PoE) connection, an on-board battery, wireless power transmission, and/or any other suitable source of power. In some examples, the range sensor 210 may include its own internal battery (e.g., a rechargeable battery) 218 that can power operations of the range sensor 210.

The range sensor 210 may further include a communication block (e.g., a communication circuit) 216 for communicating the data generated by the processing circuit 214 to external sources. For example, the communication block 216 may directly communicate the height information to automated landing legs and/or other ancillary devices in order to adjust the position of the kingpin. In some examples, the communication block 216 may communicate directly with a telematics gateway (e.g., a telematics gateway circuit) 128, which may be at the nose box of the trailer/chassis 120 and has wireless communication capability, so the data from the processing circuit 214 may be transmitted via cellular or broadband connection to an external server (and thus a dispatcher) or the tractor cab 110. The communication block 216 may transmit data to the telematics gateway 128 over a controller area network (CAN) bus of the trailer/chassis 120, an RS232/485 connection, a power line communication (PLC) connection, Wi-Fi, Bluetooth, or any other connection via a suitable protocol.

As used herein, the term “processing circuit” includes any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed wiring board (PWB) or distributed over several interconnected PWBs. A processing circuit may contain other processing circuits; for example, a processing circuit may include two processing circuits, an FPGA and a CPU, interconnected on a PWB.

In some examples, the telematics gateway 128 may use a cellular connection or a Wi-Fi connection to communicate with a remote server 10 (e.g., a remote server 10 on the cloud 20), which may compile and further process the received data. A user device 30 associated with the driver, which may be a receiver and display in the cab of the tractor 110 or a mobile device (e.g., tablet or phone) of the driver may receive information, such as the calculated wheelbase from the remote server 10 via a cellular or Wi-Fi connection. However, embodiments of the present disclosure are not limited thereto, and the range sensor 210 may communicate directly with the user device 30 via a wireless connection, such as Wi-Fi or Bluetooth.

According to some embodiments, the range sensor 210 is configured to measure the distance to ground 40 and to process and transmit data based on the measured distance to the telematics gateway 128. The transmitted data may include the height of kingpin 122 (e.g., the distance from the bottom of the kingpin to ground), the calibration value (e.g., the vertical offset from the kingpin location to the sensor reading location), the sensor reading horizontal distance from the kingpin (e.g., to enable accounting for angular deviations), the input voltage to the sensing device 200, confidence of the reading, and/or the like. When relayed to a driver, a controller or control system within the vehicle or a dispatcher, this information may be instrumental in ensuring that the fifth wheel 112 and the kingpin 122 are properly aligned vertically.

The sensing device 200 is designed to be easily installed during trailer manufacture or a retrofit.

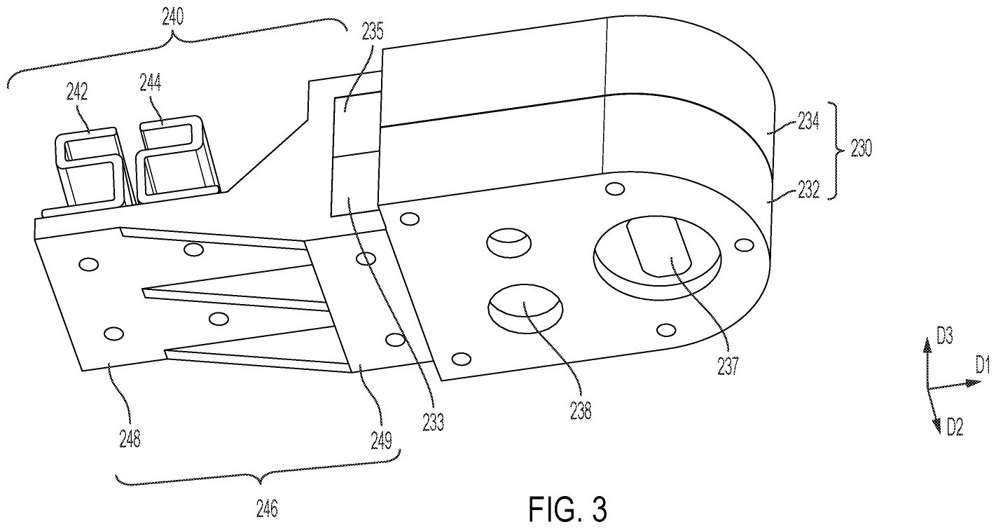

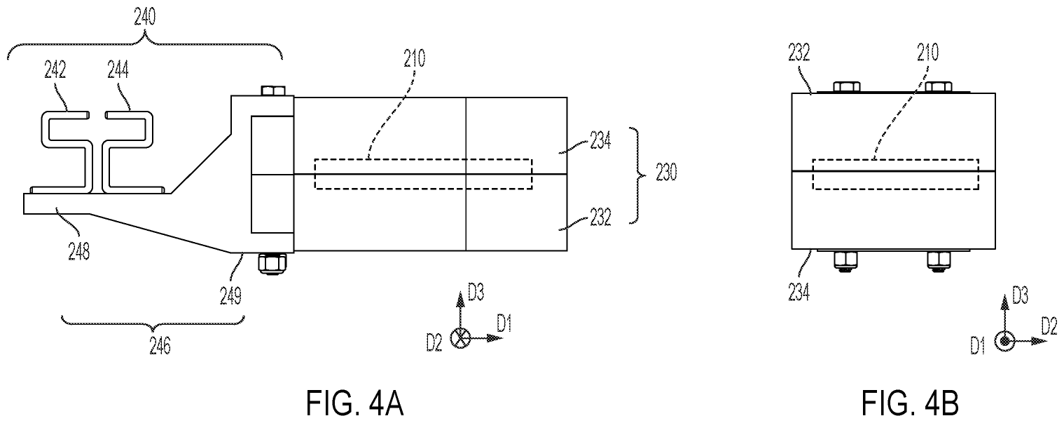

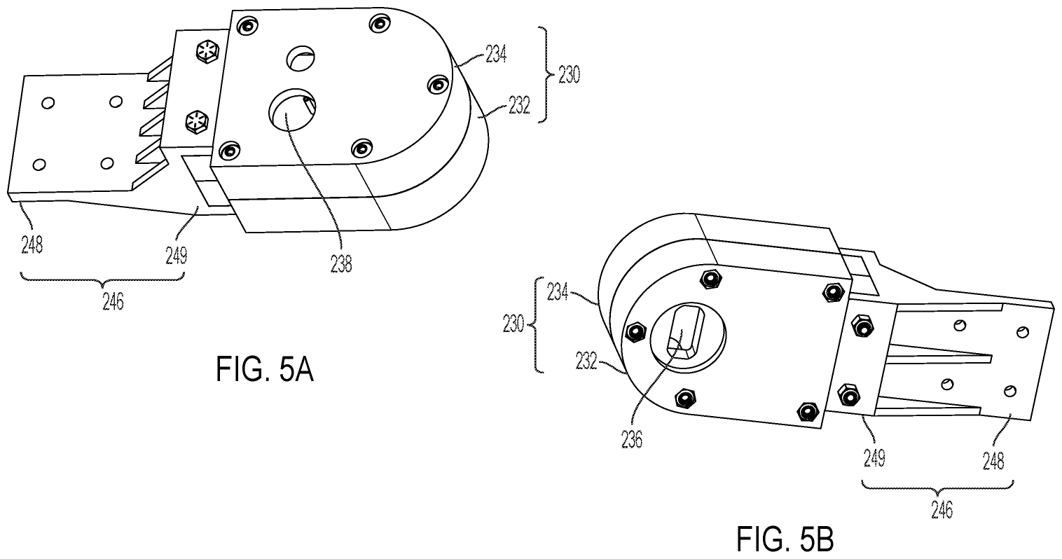

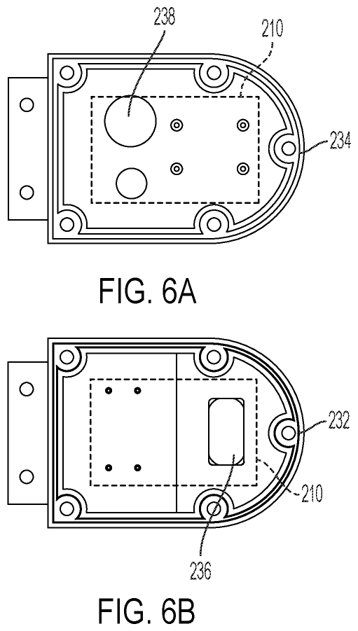

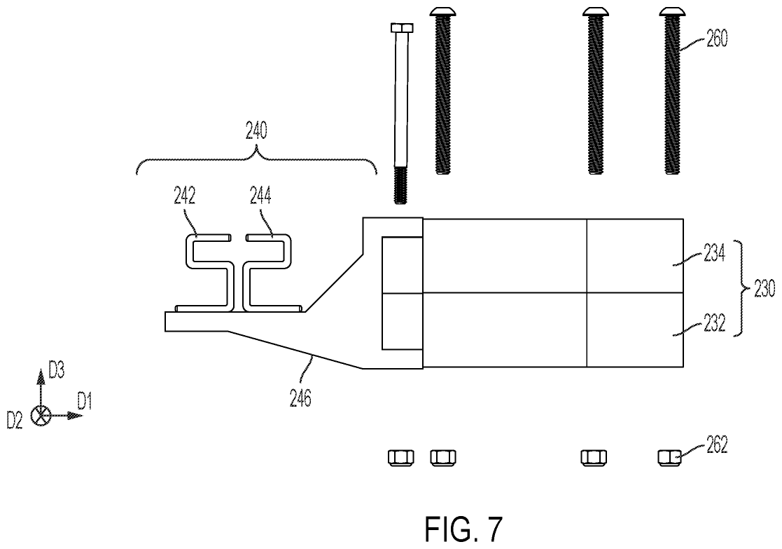

FIG. 3 illustrates a bottom perspective view of the sensing device 200, according to some embodiments of the present disclosure. FIGS. 4A and 4B illustrate a side view and a frontal view, respectively, of the sensing device 200, according to some embodiments of the present disclosure. FIGS. 5A and 5B illustrate a top perspective view and a bottom perspective view, respectively, of the sensing device 200, according to some embodiments of the present disclosure. In FIGS. 5A-5B the fasteners 242 and 244 have been omitted for clarity of illustration. FIGS. 6A-6B illustrate and interior view of the top portion 234 and the bottom portion 232, respectively, of the sensor housing 230, according to some embodiments of the present disclosure. FIG. 7 illustrates a partially exploded side-view of sensing device 200, according to some embodiments of the present disclosure.

In some embodiments, the range sensor 210 is housed within the sensor housing 230, which protects the range sensor 210 from the elements and external impacts. The sensor housing 230 is attached to a coupling member 240 that is configured to couple the sensor housing 230 to the body of the trailer/chassis 120.

The sensor housing 230 may include a first housing portion (e.g., a bottom portion) 232 and a second housing portion (e.g., a top portion) 234 that define a hollow interior space, which is configured to house the range sensor 210 (shown in dashed lines in FIGS. 4A-4B and 6A-6B). In some examples, the first and second body portions have first and second protrusions 233 and 235, respectively, that extend along a first direction D1 and allow the sensor housing 230 to be coupled to the coupling member 240. As defined herein, when the sensing device 200 is mounted to the trailer/chassis 120, the first and second directions D1 and D2 may cross each other (e.g., are orthogonal to one another) and lie on a substantially horizontal plane that is substantially parallel to ground 40, and the third direction D3 may be a vertical direction aligned with or substantially aligned with the signal path of the range sensor 210.

Referring to FIGS. 3, 5A-5B, and 6A-6B, the sensor housing 230 (e.g., the first housing portion 232) has an aperture 236 (e.g., a ground-facing aperture) through which the range sensor 210 is able to transmit a signal (e.g., a light/laser or soundwave signal) toward the ground 40 and to receive the reflected signal back from the ground 40. In examples in which the range sensor emits a light signal, a transparent cover 237 (see, e.g., FIG. 3) fills or covers the aperture 236 to protect the range sensor 210 and to prevent ingress of the elements into the sensor housing. The aperture cover 237 may be made of glass or any suitable transparent material. The sensor housing 230 may also have one or more openings/holes 238 through which the electrical wires and/or cables that couple the range sensor 210 to the electrical system of the trailer/chassis 120 may pass. In some examples, the one or more openings 238 may be formed in the second housing portion 234 (see, e.g., FIG. 3) or in the first housing portion 232 (see, e.g., FIGS. 5A-5B and 6A-6B).

In some embodiments, the housing of the sensing device 200 is constructed to prevent contaminants, debris, dirt and other particulate material from covering the screen of the range sensor 210 so it can continue to operate in less than ideal environmental conditions. the material making up the sensor housing 230 may include glass-filled nylon; however, embodiments of the present disclosure are not limited thereto, and the sensor housing 230 may include any suitable material.

According to some embodiments, the coupling member 240 is configured to mount the sensor housing 230 onto a cross beam (e.g., an I-beam 126) of the undercarriage of the trailer/chassis 120. In some embodiments, the coupling member 240 includes a first fastener 242 and a second fastener 244 attached to a top side of the sensor housing 230 and facing one another, and a fixing member 246 coupled to the first and second fasteners 242 and 244 and configured to be fixedly connected to the sensor housing 230. In some examples, the fixing member 246 may have a fixing stem portion 248 with a flat region configured to be coupled to the first and second fasteners 242 and 244, and a U-shaped bracket portion 249 configured to be attached to (e.g., fixed to) the sensor housing 230. For example, the lips of the U-shaped bracket portion 249 may extend over the bottom surface of the first protrusion 233 and the top surface of the second protrusion 235 to grip the protrusions 233 and 235 of the sensor housing 230. The U-shaped bracket portion 249 of the fixing member 246 may be configured to be bolted to the protrusions 233 and 235 of the sensor housing 230 through a plurality of threaded through holes in the protrusions 233 and 235 of the sensor housing 230 (see, e.g., FIGS. 3, 5A-5B, 6A-6B, and 7).

As shown in FIGS. 4A-4B, 5A-5B, and 7, the various constituent components of the sensing device 200 are fastened together, for example, by threaded bolts 260 that pass through corresponding opening in the sensor housing 230 and coupling member 240 and are screwed into nuts 262. However, embodiments of the present disclosure are not limited thereto. For example, one or more of the various components of the sensing device 200 may be welded and/or clipped together.

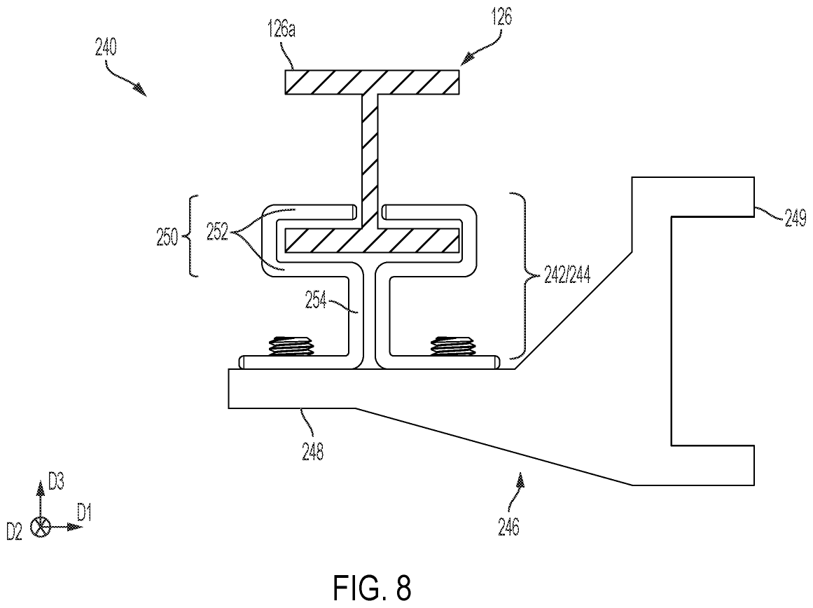

FIG. 8 illustrates a side view of a coupling member 240 of the sensing device 200, according to some embodiments of the present disclosure.

In some embodiments, the first and second fasteners 242 and 244 are shaped to grip a flange 126a of an I-beam 126 at a bottom side of the trailer/chassis 120. Each of the fasteners 242/244 includes a U-shaped clip 250 having two parallel arms 252 that extend along and overlap a flange 126a of an I-beam 126 of the trailer/chassis 120. In some examples, the parallel arms 252 extend along the second direction D2. One of the two parallel arms (e.g., the top arm when mounted) may have a threaded through hole to enable a bolt to screw through and apply compressive force against the flange of the I-beam and to fasten the U-shaped clip 250 to the I-beam 126 (see, e.g., FIG. 8). Each of the fasteners 242/244 also includes a stem 254 that extends from one of the two parallel arms (e.g., the bottom arm when mounted) and is configured to be fastened to the sensor housing 230 (e.g., via a screw or a nut and bolt; see, FIG. 8). The separation between the two stems 254 (e.g., as defined along the first direction D1) may be adjustable to accommodate I-beams with different flange widths (e.g., as measured along the first direction D1). This allows the tandem position sensor to be used with a wide variety of trailers/chassis.

While FIG. 8 illustrates a particular example of mounting the coupling member 240 to the underside of the trailer/chassis 120, embodiments of the present disclosure are not limited thereto. For example, the coupling member 240 may be welded to or bolted to the underside of the trailer/chassis 120, or may be fastened to the underside of the trailer/chassis 120 using any other suitable fastening mechanism.

As described above, the sensing device 200 confers a number of advantages over a trailer not equipped with a height sensor. For example, with the sensing device 200, the driver (or autonomous vehicle) can be alerted to the expected height of the coupled (overall semi) vehicle. This information may be desirable prior to coupling in order to act upon this data without human intervention or adjustment. Further, the sensing device 200 may act as a redundant system to provide further confirmation of the trailer height if the tow vehicle is unable to provide a reading and/or a confirmation that the fifth wheel distance matches the kingpin distance.

The present invention is not to be limited in scope by the specific embodiments described herein. Indeed, other various embodiments of and modifications to the present invention, in addition to those described herein, may be apparent to those of ordinary skill in the art from the foregoing description and accompanying drawings. Thus, such other embodiments and modifications are intended to fall within the scope of the present invention. Further, although the present invention has been described herein in the context of a particular implementation in a particular environment for a particular purpose, those of ordinary skill in the art may recognize that its usefulness is not limited thereto and that the present invention may be beneficially implemented in any number of environments for any number of purposes. Accordingly, the claims set forth below should be construed in view of the full breadth and spirit of the present invention as described herein and equivalents thereof.

It will be understood that, although the terms “first”, “second”, “third”, etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section discussed below could be termed a second element, component, region, layer or section, without departing from the spirit and scope of the inventive concept.

The terminology used herein is for the purpose of describing particular embodiments and is not intended to be limiting of the inventive concept. As used herein, the singular forms “a” and “an” are intended to include the plural forms as well, unless the context clearly indicates otherwise. It will be further understood that the terms “include,” “including,” “comprises,” “comprising,” “has,” “have,” and “having,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. For example, the expression “A and/or B” denotes A, B, or A and B. Expressions such as “one or more of” and “at least one of,” when preceding a list of elements, modify the entire list of elements and do not modify the individual elements of the list. For example, the expression “one or more of A, B, and C,” “at least one of A, B, or C,” “at least one of A, B, and C,” and “at least one selected from the group consisting of A, B, and C” indicates only A, only B, only C, both A and B, both A and C, both B and C, or all of A, B, and C.

Further, the use of “may” when describing embodiments of the inventive concept refers to “one or more embodiments of the inventive concept.” Also, the term “exemplary” is intended to refer to an example or illustration.

It will be understood that when an element or layer is referred to as being “on”, “connected to”, “coupled to”, or “adjacent” another element or layer, it can be directly on, connected to, coupled to, or adjacent the other element or layer, or one or more intervening elements or layers may be present. When an element or layer is referred to as being “directly on,” “directly connected to”, “directly coupled to”, or “immediately adjacent” another element or layer, there are no intervening elements or layers present.

As used herein, the term “substantially,” “about,” and similar terms are used as terms of approximation and not as terms of degree, and are intended to account for the inherent variations in measured or calculated values that would be recognized by those of ordinary skill in the art.

As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

The range sensor 210 and/or any other relevant devices or components according to embodiments of the present invention described herein may be implemented utilizing any suitable hardware, firmware (e.g., an application-specific integrated circuit), software, or a suitable combination of software, firmware, and hardware. For example, the various components of the range sensor 210 may be formed on one integrated circuit (IC) chip or on separate IC chips. Further, the various components of the range sensor 210 may be implemented on a flexible printed circuit film, a tape carrier package (TCP), a printed circuit board (PCB), or formed on a same substrate. Further, the various components of the range sensor 210 may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

The present disclosure is not to be limited in scope by the specific embodiments described herein. Indeed, other various embodiments of and modifications to the present disclosure, in addition to those described herein, may be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art may recognize that its usefulness is not limited thereto and that the present disclosure may be beneficially implemented in any number of environments for any number of purposes. Accordingly, the claims set forth below should be construed in view of the full breadth and spirit of the present disclosure as described herein and equivalents thereof.

Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims and equivalents thereof.

What is claimed is:

1. A sensing device comprising:
a range sensor configured to emit a signal toward the ground and to measure a distance between the range sensor and the ground;
a sensor housing configured to house the range sensor, the sensor housing having a first opening through which the range sensor is configured to emit the signal; and
a coupling member attached to the sensor housing and configured to couple the sensor housing to a body of a trailer or a chassis.

2. The sensing device of claim 1, wherein the range sensor comprises a time-of-flight (ToF) sensor, and the signal comprises a light signal or a sound wave.

3. The sensing device of claim 1, wherein the range sensor comprises:
an emitter configured to emit the signal toward the ground;
a receiver configured to receive a reflected signal from the ground; and
a processing circuit configured to calculate the distance between the range sensor and the ground based on an emission time of the signal and a receive time of the reflected signal, and to determine a height of a kingpin of the trailer or the chassis based on the calculated distance.

4. The sensing device of claim 3, wherein the processing circuit is configured to determine the height of the kingpin further based on a calibration value corresponding to a vertical distance between the kingpin and the range sensor.

5. The sensing device of claim 3, wherein the range sensor further comprises:
a communication circuit in electrical communication with a telematics gateway circuit at the trailer or the chassis, and configured to transmit data generated by the processing circuit to the telematics gateway circuit over a controller area network (CAN) bus of the trailer or the chassis, an RS232/485 connection, a power line communication (PLC) connection, or a wireless communication link.

6. The sensing device of claim 1, wherein the range sensor is coupled to an electrical system of the trailer or the chassis, and is configured to receive electrical power from at least one of an electrical circuit of an anti-lock braking system (ABS) of the trailer or the chassis, a light circuit providing power to lights of the trailer or the chassis, a power-over-ethernet (PoE) connection, or a storage battery at the trailer or the chassis.

7. The sensing device of claim 1, wherein the range sensor is configured to determine a height of a kingpin of the trailer or the chassis based on the distance between the range sensor and the ground, and to transmit the height of the kingpin.

8. The sensing device of claim 1, wherein the sensor housing accommodates the range sensor and is fixedly coupled to the coupling member.

9. The sensing device of claim 1, wherein the sensor housing comprises glass-filled nylon material.

10. The sensing device of claim 1, wherein the coupling member comprises:
a fixing member; and
a first fastener and a second fastener facing one another, the first and second fasteners being configured to be attached to the fixing member and to grip a flange of an I-beam at an underside of the trailer or the chassis.

11. The sensing device of claim 10, wherein the first fastener comprises:
a first U-shaped clip having two parallel arms that extend along and overlap the flange, one of the two parallel arms having a threaded through hole to enable a bolt to screw through and apply compressive force against the flange of the I-beam and to fasten the first U-shaped clip to the I-beam; and
a first stem extending from an other one of the two parallel arms and configured to be fastened to the fixing member.

12. The sensing device of claim 10, wherein the fixing member has a fixing stem portion configured to be coupled to the first and second fasteners, and a U-shaped bracket portion configured to be mounted to two sides of the sensor housing.

13. A sensing device comprising:
a sensor housing configured to be coupled to a body of a trailer or a chassis, the trailer or chassis having a kingpin configured to couple the trailer or the chassis to a tractor; and
a range sensor in the sensor housing and configured to emit a signal toward the ground, to measure a distance between the range sensor and the ground, and to determine a height of the kingpin based on the measured distance.

14. The sensing device of claim 13, wherein the range sensor is further configured to receive a reflected signal from the ground, to calculate the distance between the range sensor and the ground based on an emission time of the signal and a receive time of the reflected signal, and to determine the height of the kingpin of the trailer or the chassis based on the calculated distance and a calibration value corresponding to a vertical distance between the kingpin and the range sensor.

15. The sensing device of claim 13, wherein the range sensor is configured to be in electrical communication with at least one of a telematics gateway circuit at the trailer or the chassis, the tractor coupled to the trailer or the chassis, or automated landing legs of the trailer or the chassis.

16. The sensing device of claim 13, wherein the range sensor is configured to transmit data corresponding to the height of the kingpin to a telematics gateway circuit at the trailer or the chassis over a controller area network (CAN) bus of the trailer or the chassis, an RS232/485 connection, a power line communication (PLC) connection, or a wireless communication link.

17. The sensing device of claim 13, further comprising:
a coupling member attached to the sensor housing and configured to couple the sensor housing to an underside of the trailer or the chassis, the coupling member comprising:
a fixing member; and
a first fastener and a second fastener facing one another, the first and second fasteners being configured to be attached to the fixing member and to grip a flange of an I-beam at the underside of the trailer or the chassis.

18. A vehicle height sensing system comprising:
a sensing device comprising:
a sensor housing configured to be coupled to a body of a trailer or a chassis, the trailer or chassis having a kingpin configured to couple the trailer or the chassis to a tractor; and
a range sensor in the sensor housing and configured to emit a signal toward the ground, to measure a distance between the range sensor and the ground, and to determine a height of the kingpin based on the measured distance; and
a telematics gateway circuit at the trailer or the chassis and configured to be in electrical communication with the sensing device.

19. The vehicle height sensing system of claim 18, wherein the telematics gateway circuit is at a nose box of the trailer or the chassis and is configured to wirelessly transmit data corresponding to the height of the kingpin via a cellular or a broadband connection to an external server or a tractor cab.

20. The vehicle height sensing system of claim 18, wherein the range sensor is configured to transmit data corresponding to the height of the kingpin to the telematics gateway circuit over a controller area network (CAN) bus of the trailer or the chassis, an RS232/485 connection, a power line communication (PLC) connection, or a wireless communication link.
